(19) United States
(12) Patent Application Publication
(10) Pub. No.: US 2016/0061021 A1
(43) Pub. Date: Mar. 3, 2016

(54) Cement Evaluation

(71) Applicant: SCHLUMBERGER TECHNOLOGY CORPORATION, Sugar Land, TX (US)

(72) Inventors: Pavel Shaposhnikov, Katy, TX (US); Donna Findlater, Aberdeenshire (GB); Gioconda Tovar, Katy, TX (US)

(21) Appl. No.: 14/781,667

(22) PCT Filed: Apr. 1, 2014
(86) PCT No.: PCT/US2014/032490

§ 371 Date: Oct. 1, 2015

Related U.S. Application Data
(60) Provisional application No. 61/807,282, filed on Apr. 1, 2013.

(51) Int. Cl. E21B 47/00; G01V 1/46

(52) U.S. Cl. CPC E21B 47/0005; G01V 1/46

(57) ABSTRACT

Systems and methods for evaluating a cement installation are provided. In one example, the cement may be evaluated using an objective indicator or index calculated from acoustic measurements. In another example, the cement may be evaluated in an integrated cement evaluation that integrates data relevant to cement obtained from a variety of previous operations used to drill and complete the well.

### BACKGROUND

This disclosure relates to systems and methods for evaluating cement behind a casing of a wellbore.

This section is intended to introduce the reader to various aspects of art that may be related to various aspects of the present techniques, which are described and/or claimed below. This discussion is believed to be helpful in providing the reader with background information to facilitate a better understanding of the various aspects of the present disclosure. Accordingly, it should be understood that these statements are to be read in this light, and not as admissions.

A wellbore drilled into a geological formation may be targeted to produce oil and/or gas from certain zones of the geological formation. To prevent different zones from interacting with one another via the wellbore and to prevent fluids from undesired zones from entering the wellbore, the wellbore may be completed by placing a cylindrical casing into the wellbore and cementing the casing in place. During cementing, cement may be injected into the annulus formed between the cylindrical casing and the geological formation. When the cement properly sets, fluids from one zone of the geological formation may not be able to pass through the wellbore to interact with one another. This desirable condition is referred to as “zonal isolation.” Yet well completions may not go as planned. For example, the cement may not set as planned and/or the quality of the cement may be less than expected. In other cases, the cement may unexpectedly fail to set above a certain depth due to natural fissures in the formation.

A variety of acoustic tools may be used to verify that cement is properly installed. These acoustic tools pulse acoustic waves as they are lowered through the wellbore to generate acoustic well logs (tracks of data over certain depth intervals of the well). The acoustic well logs may indicate whether liquids or solids are behind the casing in the wellbore at various depths. When the well logs indicate a solid, cement is likely present. When the well logs indicate a liquid, the cement may not have set or may not be present. Because a human operator in the field may judge the meaning of the logs, the decision of whether cement is or is not properly installed may be relatively inexact and may depend on the experience of the operator.

### BRIEF DESCRIPTION OF THE DRAWINGS

Various aspects of this disclosure may be better understood upon reading the following detailed description and upon reference to the drawings in which:

FIG. 1 is a schematic diagram of a system for verifying proper cement installation and/or zonal isolation of a well, in accordance with an embodiment;

FIG. 2 is a block diagram of an acoustic downhole tool to obtain a well log relating to a material behind casing of the well, in accordance with an embodiment;

FIG. 3 is a flowchart of an integrated cement evaluation workflow for verifying proper cement installation and/or zonal isolation of the well, in accordance with an embodiment;

FIG. 4 is a block diagram relating a response of the acoustic downhole tool to a free pipe or fully cemented pipe condition in the well, in accordance with an embodiment;

FIG. 5 is a flowchart of a method for determining a Solids Presence Indicator (SPI), Solids Index (SI), Solids Azimuthal Coverage Index (SACI), and/or Azimuthal Coverage Indicator (ACI), in accordance with an embodiment;

FIG. 6 is an example well log showing Solids Presence Indicator (SPI) and/or Solids Azimuthal Coverage Index (SACI) in relation to Cement Bond Log (CBL), Acoustic Impedance (AI), and Flexural Attenuation (FA), in accordance with an embodiment;

FIG. 7 is a flowchart of a method for determining a measurement value relating to free pipe casing (Mfp) that may be used in calculating Solids Presence Indicator (SPI), Solids Index (SI), Solids Azimuthal Coverage Index (SACI), and/or Azimuthal Coverage Indicator (ACI), in accordance with an embodiment;

FIG. 8 is a flowchart of a method for determining a measurement value of fully cemented casing (Mfc) that may be used in calculating Solids Presence Indicator (SPI), Solids Index (SI), Solids Azimuthal Coverage Index (SACI), and/or Azimuthal Coverage Indicator (ACI), in accordance with an embodiment;

FIG. 9 is a flowchart of a method for determining a measurement value of a free pipe threshold (Mfpt) that may be used in calculating Solids Presence Indicator (SPI), Solids Index (SI), Solids Azimuthal Coverage Index (SACI), and/or Azimuthal Coverage Indicator (ACI), in accordance with an embodiment;

FIG. 10 is a series of plots of Acoustic Impedance (AI) histograms that may be used to add certainty to determining the measurement value of a free pipe threshold (Mfpt), in accordance with an embodiment;

FIG. 11 is a series of plots of Flexural Attenuation (FA) histograms that may be used to add certainty to determining the measurement value of a free pipe threshold (Mfpt), in accordance with an embodiment;

FIG. 12 is another example well log showing Solids Presence Indicator (SPI) and/or Solids Azimuthal Coverage Index (SACI) in relation to Cement Bond Log (CBL), Acoustic Impedance (AI), and Flexural Attenuation (FA), in accordance with an embodiment;

FIGS. 13 and 14 are well logs for a first example circumstance that may benefit from the Solids Presence Indicator (SPI), Solids Index (SI), Solids Azimuthal Coverage Index (SACI), and/or Azimuthal Coverage Indicator (ACI), in accordance with an embodiment;

FIGS. 15-17 are well logs for a second example circumstance that may benefit from the Solids Presence Indicator (SPI), Solids Index (SI), Solids Azimuthal Coverage Index (SACI), and/or Azimuthal Coverage Indicator (ACI), in accordance with an embodiment;

FIG. 18 is a flowchart of a method for integrated cement evaluation, in accordance with an embodiment;

FIG. 19 is a block diagram of various factors that may be considered in the integrated cement evaluation of FIG. 18, in accordance with an embodiment;

FIG. 20 is a flowchart of a method for evaluating the factors that may be considered in the integrated cement evaluation of FIG. 18, in accordance with an embodiment;

FIG. 21 is a flowchart of a method for performing integrated cement evaluation, in accordance with an embodiment;

FIG. 22 is a block diagram of an integrated well log for integrated cement evaluation, in accordance with an embodiment; and

FIG. 23 is an example of an integrated well log for integrated cement evaluation, in accordance with an embodiment.

### SUMMARY

A summary of certain embodiments disclosed herein is set forth below. It should be understood that these aspects are presented merely to provide the reader with a brief summary of these certain embodiments and that these aspects are not intended to limit the scope of this disclosure. Indeed, this disclosure may encompass a variety of aspects that may not be set forth below.

Systems and methods for obtaining indices and/or indicators and/or integrated cement evaluation are disclosed herein. In one example, a method involves obtaining at least one acoustic tool response over a depth interval in a cased and cemented well and determining a value of a measurement at a depth based at least in part on the at least one acoustic tool response. A measurement value associated with a free pipe casing, a measurement value associated with a fully cemented casing, and a measurement value associated with a free pipe threshold may be determined. Using these, an indicator or an index relating the measurement at the depth to a presence or absence of cement at the depth may be determined, based at least in part on: the value of the measurement, the measurement value associated with a free pipe casing, the measurement value associated with a fully cemented casing, and the measurement value associated with a free pipe threshold. The measurement value associated with the free pipe threshold may be determined according to an objective determination that may be less subject to personnel individualities than otherwise.

In another example, a tangible, non-transitory, machine-readable medium may include processor-executable instructions to receive acoustic log measurement values over a depth interval of a well that has been at least attempted to be cased and cemented, determine a measurement value associated with a free pipe casing, determine a measurement value associated with a fully cemented casing, determine an objective measurement value associated with a free pipe threshold, and calculate an indicator or an index relating the measurement at the depth to a presence or absence of cement over the depth interval based at least in part on the value of the measurement, the measurement value associated with a free pipe casing, the measurement value associated with a fully cemented casing, and the measurement value associated with a free pipe threshold.

In another example, an integrated cement evaluation well log may include at least a track that includes data obtained by an acoustic cement evaluation logging tool and at least another track relating to logging-while-drilling or open hole logging information, drilling information, wellbore information, well completion information, cement design information, or cement execution information, or some combination of these.

In another example, a method involves designing a well to be drilled into a geological formation, drilling a wellbore of the well into the geological formation, completing the well at least by installing casing and cement, and evaluating the installation of the cement. While the well is being designed, drilled, and/or completed, data relevant to cement installation is identified as relevant to the cement installation and stored. This data relevant to the cement installation is used in evaluating the cement installation.

Various refinements of the features noted above may be undertaken in relation to various aspects of the present disclosure. Further features may also be incorporated in these various aspects as well. These refinements and additional features may exist individually or in any combination. For instance, various features discussed below in relation to one or more of the illustrated embodiments may be incorporated into any of the above-described aspects of the present disclosure alone or in any combination. The brief summary presented above is intended to familiarize the reader with certain aspects and contexts of embodiments of the present disclosure without limitation to the claimed subject matter.

### DETAILED DESCRIPTION

One or more specific embodiments of the present disclosure will be described below. These described embodiments are examples of the presently disclosed techniques. Additionally, in an effort to provide a concise description of these embodiments, features of an actual implementation may not be described in the specification. It should be appreciated that in the development of any such actual implementation, as in any engineering or design project, numerous implementation-specific decisions may be made to achieve the developers' specific goals, such as compliance with system-related and business-related constraints, which may vary from one implementation to another. Moreover, it should be appreciated that such a development effort might be complex and time consuming, but would still be a routine undertaking of design, fabrication, and manufacture for those of ordinary skill having the benefit of this disclosure.

When introducing elements of various embodiments of the present disclosure, the articles “a,” “an,” and “the” are intended to mean that there are one or more of the elements. The terms “comprising,” “including,” and “having” are intended to be inclusive and mean that there may be additional elements other than the listed elements. Additionally, it should be understood that references to “one embodiment” or “an embodiment” of the present disclosure are not intended to be interpreted as excluding the existence of additional embodiments that also incorporate the recited features.

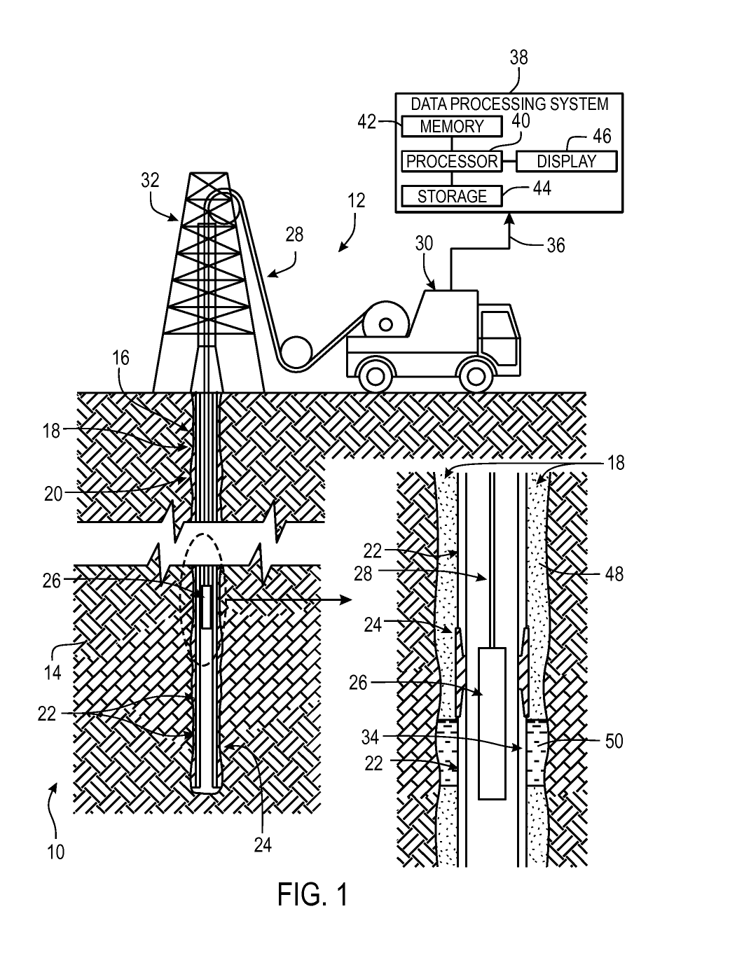

This disclosure relates to systems and methods for evaluating cement behind a casing of a wellbore. For example, FIG. 1 schematically illustrates a system 10 for evaluating cement behind casing in a well. In particular, FIG. 1 illustrates surface equipment 12 above a geological formation 14. In the example of FIG. 1, a drilling operation has previously been carried out to drill a wellbore 16. In addition, cement 18 has been used to seal an annulus 20—the space between the wellbore 16 and casing joints 22 and collars 24—with cementing operations.

As seen in FIG. 1, several casing joints 22 (also referred to below as casing 22) are coupled together by the casing collars 24 to stabilize the wellbore 16. The casing joints 22 represent lengths of conductive pipe, which may be formed from steel or similar materials. In one example, the casing joints 22 each may be approximately 13 m or 40 ft long, and may include an externally threaded (male thread form) connection at each end. A corresponding internally threaded (female thread form) connection in the casing collars 24 may connect two nearby casing joints 22. Coupled in this way, the casing joints 22 may be assembled to form the casing string 18 to a suitable length and specification for the wellbore 16. The casing joints 22 and/or collars 24 may be made of carbon steel, stainless steel, or other suitable materials to withstand a variety of forces, such as collapse, burst, and tensile failure, as well as chemically aggressive fluid.

The surface equipment 12 may carry out various well logging operations to detect conditions of the wellbore 16. The well logging operations may measure parameters of the geological formation 14 (e.g., resistivity or porosity) and/or the wellbore 16 (e.g., temperature, pressure, fluid type, or fluid flowrate). As will be discussed in greater detail below, some of these measurements may be obtained at various points in the design, drilling, and completion of the well, and may be used in an integrated cement evaluation. Other measurements may be obtained to that are specifically used to verify the cement installation and the zonal isolation of the wellbore 16. An acoustic logging tool 26 may obtain some of these measurements.

The example of FIG. 1 shows the acoustic logging tool 26 being conveyed through the wellbore 16 by a cable 28. Such a cable 28 may be a mechanical cable, an electrical cable, or an electro-optical cable that includes a fiber line protected against the harsh environment of the wellbore 16. In other examples, however, the acoustic logging tool 26 may be conveyed using any other suitable conveyance, such as coiled tubing. The acoustic logging tool 26 may be, for example, a cement bond logging (CBL) tool, an UltraSonic Imager (USI) tool, and/or an Isolation Scanner (IS) tool by Schlumberger Technology Corporation. Thus, the acoustic logging tool 26 may obtain measurements of amplitude and variable density from sonic acoustic waves, acoustic impedance from ultrasonic waves, and/or flexural attenuation and velocity from the third interface echo. The availability of these five independent measurements may be used to increase confidence in the evaluation interpretation made possible by the acoustic logging tool 26. Using one or more of these or similar measurements, cement quality indicators and/or indices may be derived to further improve cement evaluation. These cement quality indicators and/or indices may include a Solids Presence Indicator (SPI), Solids Index (SI), Solids Azimuthal Coverage Index (SACI), and/or Azimuthal Coverage Indicator (ACI). This disclosure will describe the calculation of these indices and/or indicators further below.

The acoustic logging tool 26 may be deployed inside the wellbore 16 by the surface equipment 12, which may include a vehicle 30 and a deploying system such as a drilling rig 32. Data related to the geological formation 14 or the wellbore 16 gathered by the acoustic logging tool 26 may be transmitted to the surface, and/or stored in the acoustic logging tool 26 for later processing and analysis. As discussed below, the vehicle 30 may be fitted with or may communicate with a computer and software to perform data collection and analysis.

FIG. 1 also schematically illustrates a magnified view of a portion of the cased wellbore 16. As mentioned above, the acoustic logging tool 26 may obtain acoustic measurements relating to the presence of solids or liquids behind the casing 22. For instance, the acoustic logging tool 26 may obtain an indication of the degree of solidity of the cement 18 at a location 34. When the acoustic logging tool 26 provides such measurements to the surface equipment 12 (e.g., through the cable 28), the surface equipment 12 may pass the measurements as data 36 to a data processing system 38 that includes a processor 40, memory 42, storage 44, and/or a display 46. In other examples, the data 36 may be processed by a similar data processing system 38 at any other suitable location. The data processing system 38 may collect the data 36 and determine one or more indices and indicators that, as discussed further below, may objectively indicate the presence or absence of properly installed cement. Additionally or alternatively, the data processing system 38 may correlate a variety of data obtained throughout the creation of the well (e.g., design, drilling, logging, well completion, etc.) that may assist in the evaluation of the cement. Namely, the processor 40, using instructions stored in the memory 42 and/or storage 44, may calculate the indicators and/or indices and/or may collect and correlate the other data into an integrated cement evaluation well log. As such, the memory 42 and/or the storage 44 of the data processing system 38 may be any suitable article of manufacture that can store the instructions. The memory 42 and/or the storage 44 may be ROM, random-access memory (RAM), flash memory, an optical storage medium, or a hard disk drive, to name a few examples. The display 46 may be any suitable electronic display that can display the logs, indices, and/or indicators relating to the cement evaluation.

In this way, the data 36 from the acoustic logging tool 26 may be used to determine whether the cement 18 has been installed as expected. The logs, indices, and/or indicators may indicate that the cement 18 has a generally solid character (e.g., as indicated at numeral 48) and therefore has properly set. The logs, indices, and/or indicators may also indicate that the cement 18 has a generally liquid character (e.g., as indicated at numeral 50), which may imply that the cement 18 has not properly set. For example, when the logs, indices, and/or indicators indicate the cement 18 has the generally liquid character as indicated at numeral 50, this may imply that the cement has drained away, was of the wrong type or consistency, and/or that fluid channels have formed in the cement 18. By generating the logs, indices, and/or indicators described in this disclosure, ascertaining the character of the cement 18 may be more objective and less dependent on the subjective experience of the human operator in the field that may interpret the data 36 from the acoustic logging tool 26.

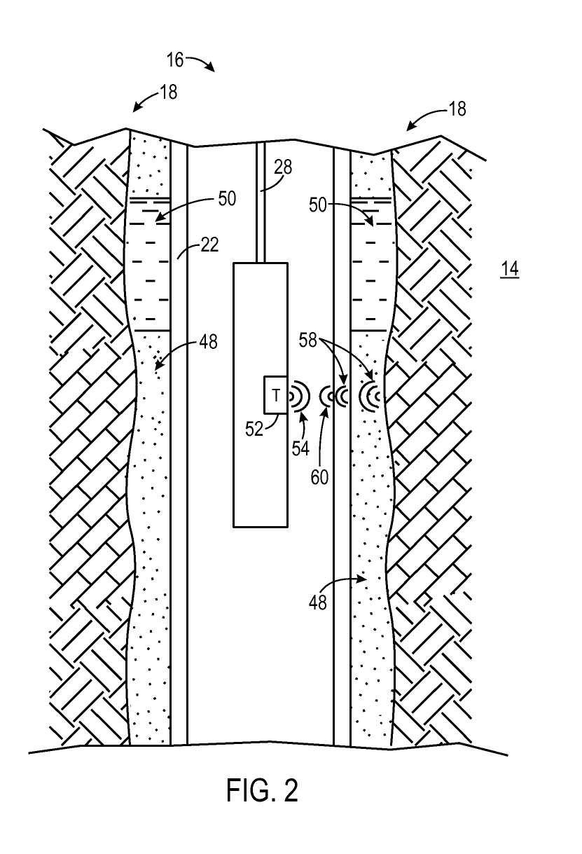

With this in mind, FIG. 2 describes an example of the operation of the acoustic logging tool 26 in the wellbore 16. Specifically, a transducer 54 in the acoustic logging tool 26 may emit acoustic waves 54 out toward the casing 22. Reflected waves 56, 58, and 60 may correspond to interfaces at the casing 22, the cement 18, and the geological formation 14, respectively. The reflected waves 56, 58, and 60 may vary depending on whether the cement 18 is of the generally solid character 48 or the generally liquid character 50. The acoustic logging tool 26 may use any suitable number of different techniques, including measurements of amplitude and variable density from sonic acoustic waves, acoustic impedance from ultrasonic waves, and/or flexural attenuation and velocity from the third interface echo. There are mathematical models with each method that are used to calculate properties of the material in the annulus 20. As mathematical models, many assumptions and simplifications of the real world may be employed. These may involve corrections and calibration or reference point checks.

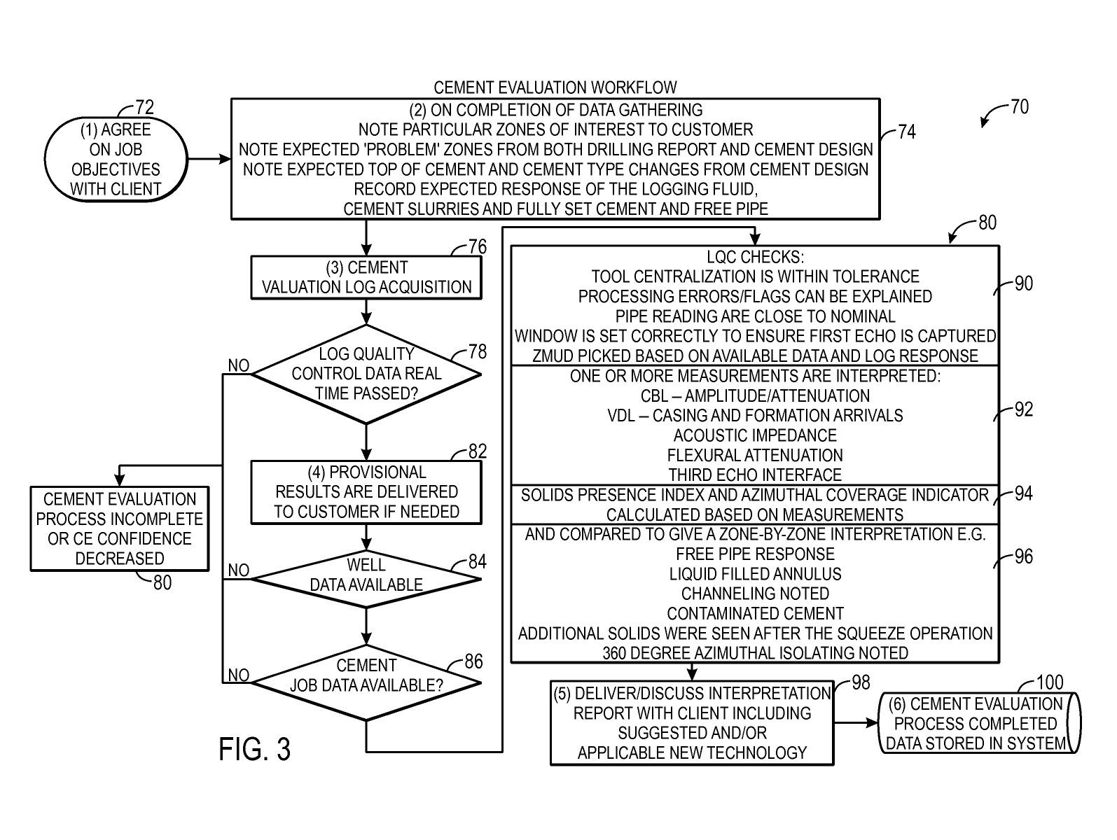

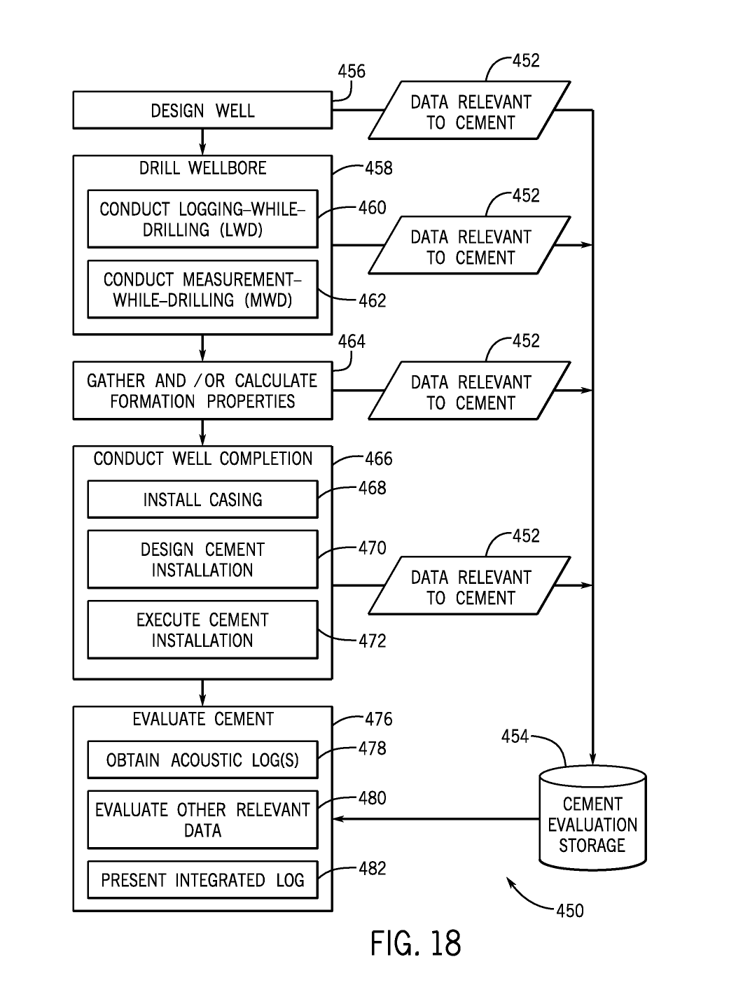

To verify that the cement 18 has properly set, a cement evaluation workflow shown in a flowchart 70 of FIG. 3 may be followed. The cement evaluation workflow in the flowchart 70 may begin after a well has been drilled, completed, and cemented. It should be appreciated, however, that data related to the previous operations creating the well may be stored and used in evaluating the cement 18, as discussed below with reference to FIG. 18.

In the cement evaluation workflow of the flowchart 70, objectives of the cement job first may be agreed upon with the client (block 72). Various data may be gathered (e.g., as discussed below with reference to FIGS. 5 and 18-21) (block 74). At this point, particular zones of interest to the customer may be noted; expected “problem” zones that may create difficulties from a drilling report and/or cement design may be noted; the expected location of the top of the cement 18 in the well may be noted; changes in the cement type and cement design may be noted; and/or the expected response of logging fluid surrounding the acoustic logging tool 26 in the wellbore 16, cement 18 slurries, fully set cement 18, and free pipe (i.e., no cement 18 behind the casing 22) may be recorded.

A cement evaluation log may be acquired (block 76) using the data 36 from the acoustic logging tool 26 and/or from various other data obtained previously. If the log data does not pass a quality control, whether in real time as shown in FIG. 3 or otherwise as in other embodiments (decision block 78), the cement evaluation process may be deemed incomplete or a degree of confidence of the ultimate cement evaluation may be decreased (block 80). If the log data does pass the quality control (decision block 78), the provisional results may be presented to the customer (block 82). In addition, if the well data is not available (decision block 84) and/or if the cement job data is not available (decision block 86), the cement evaluation process may be deemed incomplete or a degree of confidence of the ultimate cement evaluation may be decreased (block 80). Additionally or alternatively, incomplete data may be interpolated.

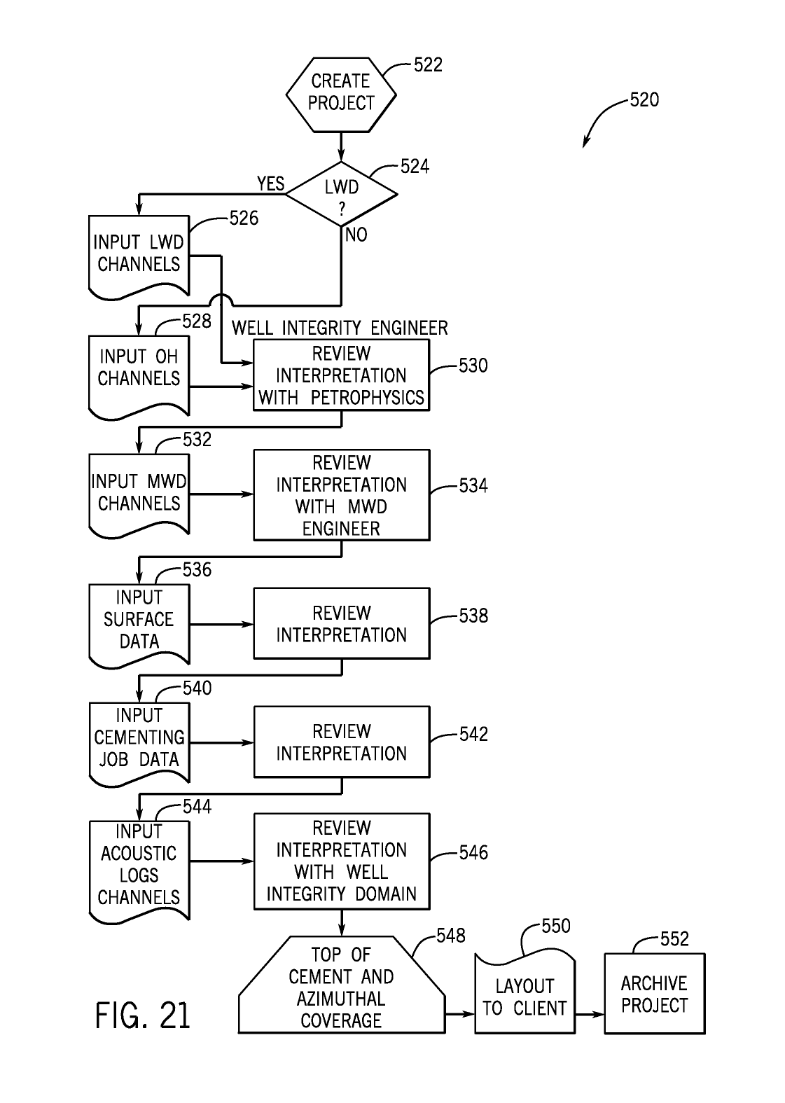

Provided the cement evaluation is not deemed to be incomplete, more complete results may be calculated and compiled (block group 88). For example, various quality control checks may be carried out (block 90). One or more measurements obtained from the response of the acoustic logging tool 26 may be interpreted (block 92). The interpretation of block 92 may take place as discussed below with reference to FIG. 21. At block 94, a Solids Presence Indicator (SPI), Solids Index (SI), Solids Azimuthal Coverage Index (SACI), and/or Azimuthal Coverage Indicator (ACI) may be calculated based on the measurements of block 92 and using confidences determined based on any suitable factors. These confidences may include, for example, statistical analysis of the measurements of block 92 and/or analysis of the quality checks of block 90. The SPI, SI, SACI, and/or ACI of block 94 then may be presented alongside and/or compared with the measurements of block 92 (block 96). This may be presented to the client (block 98) and/or may be stored (block 100).

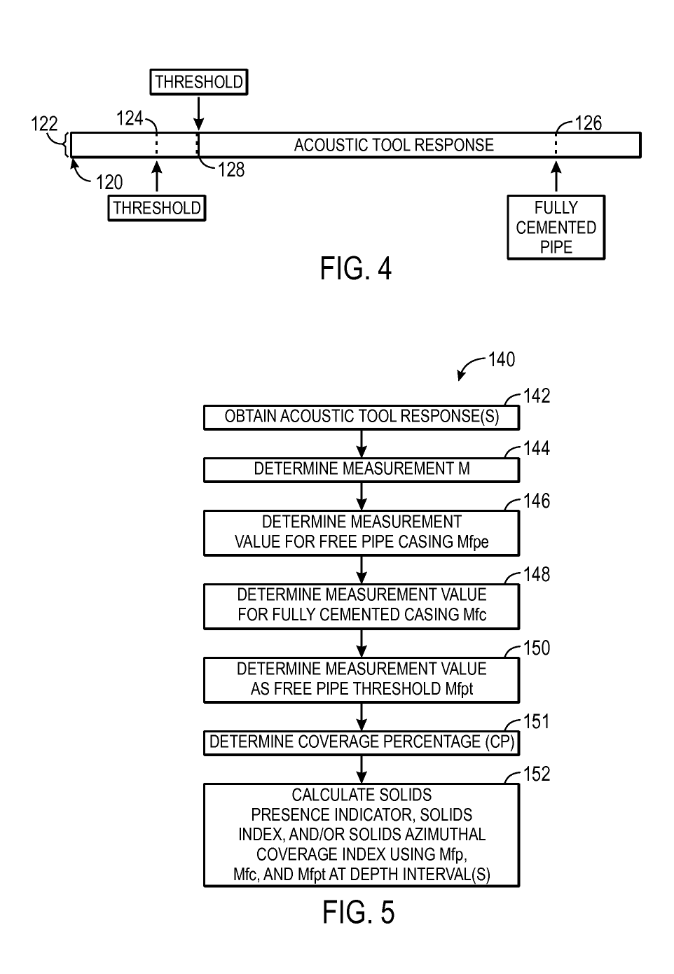

FIG. 4 illustrates an example of the interpretation of a range of responses 120 of the acoustic logging tool 26 over an interval 122. The particular response of the acoustic logging tool 26 may vary over the depths of the wellbore 16 and may indicate, for example, a free pipe condition 124 when no cement 18 is present behind the casing 22 or a fully cemented pipe 126 when the cement 18 is fully set as expected. The threshold 128 between interpreting fully set cement 18 and improperly set cement 18 (or a lack of cement 18) may be determined in an objective fashion to generate the Solids Presence Indicator (SPI), Solids Index (SI), Solids Azimuthal Coverage Index (SACI), and/or Azimuthal Coverage Indicator (ACI).

Specifically, as shown in a flowchart 140 of FIG. 5, the Solids Presence Indicator (SPI), Solids Index (SI), Solids Azimuthal Coverage Index (SACI), and/or Azimuthal Coverage Indicator (ACI) may be calculated after obtaining one or more responses of the acoustic logging tool 26 (block 142). A measurement M may be determined from the responses (block 144). The measurement M may be obtained by filtering one or more of the responses of the acoustic logging tool 26 and/or combining responses from multiple acoustic logging tools 26. It may be appreciated that different acoustic logging tools 26 may have different accuracies and characteristics; these differences may be considered in selecting the measurement M and/or other values (e.g., the measurement value of free pipe threshold Mfpt discussed below). Some of the differences between the measurements are shown below in Table 1:

| Cement | | High | |
|---|---|---|---|
| Evaluation | Quantitative - Y | Azimuthal | Confidence in the |
| Measurement | Qualitative - N | Resolution | Measurement |
| CBL | | | |
| amplitude | Y | N | Uses calibration and |
| | | | affected by borehole |
| | | | conditions |
| attenuation | Y | N | Compensated attenu- |
| | | | ation independent of |
| | | | borehole |
| VDL | N | N | |
| Pulse Echo | Y | Y | Model based and uses |
| based Acoustic | | | proper parameterization |
| impedance | | | of borehole conditions |
| Flexural mode | Y | Y | Calibrated attenuation. |
| attenuation | | | Slight dependence of |
| | | | proper parameterization |
| | | | of borehole conditions |
| Third interface | | | |
| echo | | | |
| TIE amplitude | Y | Y | Dependent on casing |
| | | | centralization and |
| | | | annulus standoff |
| TIE annular | Y | Y | Uses information on |
| acoustic | | | borehole size (caliper) |
| velocity | | | |

The measurement can be any acoustic measurement of the attenuation of the acoustic wave propagation generated in the casing string. This measurement is desired to have linear dependency between and quality of the cement. These two properties of the measurement can be achieved by converting measurement value (for example using “Logarithm” for CBL) or by looking at specific range of measurements where these properties are valid. For example, CBL measurement is not linear to quality of the cement, but CBL attenuation is (according to the laboratory tests); acoustic impedance measurement is linear; flexural attenuation is linear within low range of the measurements (liquids and light or contaminated cements). Measurements over evanescent point could be interpreted as good cement by combining flexural attenuation interpretation with acoustic impedance measurement.

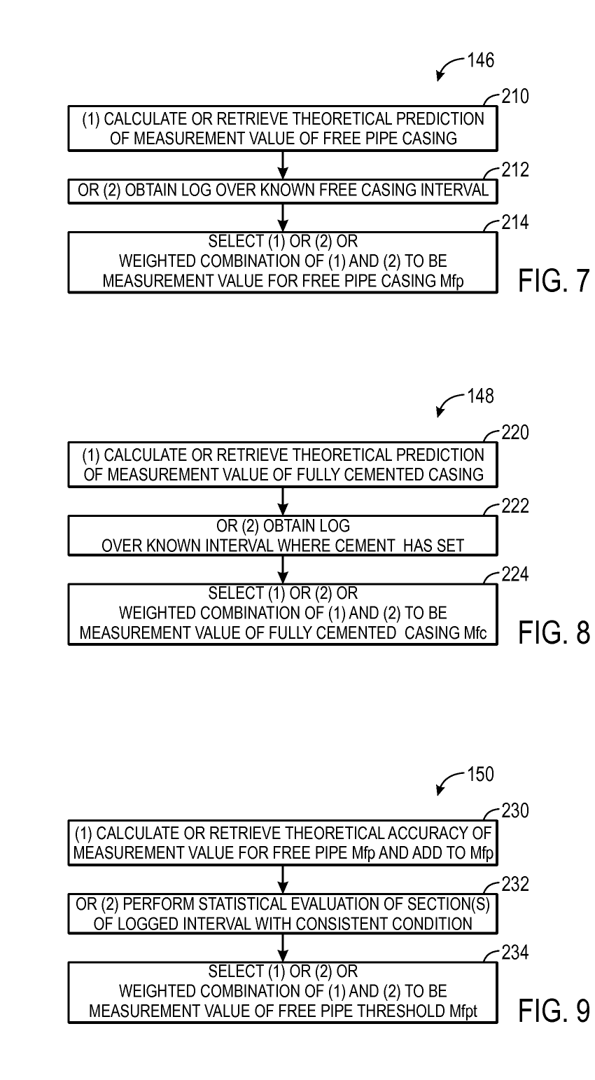

Having determined the measurement M, several variables may be determined using, for example, the data processing system 38. These include a measurement value for free pipe casing Mfp (block 146 and described further with reference to FIG. 7), a measurement value for fully cemented casing Mfc (block 148 and described further with reference to FIG. 8), a measurement value to serve as a free pipe threshold Mfpt (block 150 and discussed further with reference to FIG. 9), and a coverage percentage CP relating to a suitable amount of azimuthal cement 18 coverage to be considered fully azimuthally covered (block 151). Using these values, the data processing system 38 may calculate the Solids Presence Indicator (SPI), Solids Index (SI), Solids Azimuthal Coverage Index (SACI), and/or Azimuthal Coverage Indicator (ACI) (block 152).

### Solids Presence Indicator (SPI), Solids Index (SI), Solids Azimuthal Coverage Index (SACI), and/or Azimuthal Coverage Indicator (ACI)

In one example, the data processing system 38 may determine the Solids Presence Indicator (SPI), Solids Index (SI), Solids Azimuthal Coverage Index (SACI), and/or Azimuthal Coverage Indicator (ACI) as follows:

M—measurement (for this disclosure, any suitable acoustic cement evaluation measurement)
Mav—Azimuthally average measurement value
Mi—Each azimuthal measurement value (1<=i<=N—where N number of azimuthal measurements)
Interpretation parameters:
Mfp—Measurement value for free pipe casing
Mfc—Measurement value for fully cemented casing
Mfpt—Threshold for measurement value, particularly solid/liquid threshold
CP—Coverage percentage, representing a percentage of azimuthal data read over threshold value

1. Solids Presence Indicator:

$$SPI = \{ \begin{matrix}0 , M \leq {M}_{fpt} \\ 1 , M > {M}_{fpt}\end{matrix}$$

2. Solids Index:

$$SI = \frac{( M - {M}_{fp} )}{( {M}_{fc} - {M}_{fp} )} M = {M}_{av} for azimuthal measurement$$

3. Solids Azimuthal Coverage Index:

$$SACI = \frac{1}{N} \times {\sum }_{i = 1}^{N} \{ \begin{matrix}0 , {M}_{i} \leq {M}_{fpt} \\ 1 , {M}_{i} > {M}_{fpt}\end{matrix}$$

4. Azimuthal Coverage Indicator:

$$ACI = \{ \begin{matrix}0 , SACI < CP \\ 1 , SACI \geq CP\end{matrix}$$

Interpretation or mean for this indicators and index are:
SPI—Solids Presence Indicator flags when the measurement is reading higher then threshold level of the free pipe response. It points out that measurement is indicating presence of solids behind the casing at specific depth.
SI—Solids Index is an analog of the Bond Index. It is defined as “0” for free casing and “1” for 100% cemented as expected casing. It indicates linear percentage if readings are between expected “0” and “1”. It is well suited for measurements that have a linear response between free casing and 100% cemented casing, such as CBL attenuation (or Log of amplitude), acoustic impedance, or flexural attenuation when values of flexural attenuation remain below evanescence point.
SACI—Solid Azimuthal Coverage Index shows percentages of the azimuthal measurements at specific depth that are reading above predetermine threshold such as free pipe response. “0” can be interpreted as meaning that each azimuthal measurement is below the threshold, indicating free casing. “1” can be interpreted as meaning that each azimuthal measurement is above/past free casing threshold indicating that solids are covering azimuthally 100% of the casing.
ACI—Azimuthal coverage indicator is a flag. It flags “1” when CP percent of the azimuthal measurements read solids. With CP=100% ACI flags when solids provide full azimuthal coverage.
A statistical approach can also be taken for light cements: for example, with CP set at 95%, ACI will flag when there are 95% of the azimuthal measurements read above the threshold. It should be carefully considered, however, that a narrow channel with a width smaller or around resolution of the sensor may be not flagged with this index, but rather just may be identified visually in some cases. Under these conditions, an interpretation becomes subjective. It also should be noted there are other statistical methods that may allow classifying “possibly solids” based on variation of the data.
These indicators may allow quick answers to questions that may arise during cement evaluation:
The top of the cement can be linked with SPI
Hydraulic isolation can be associated with ACI

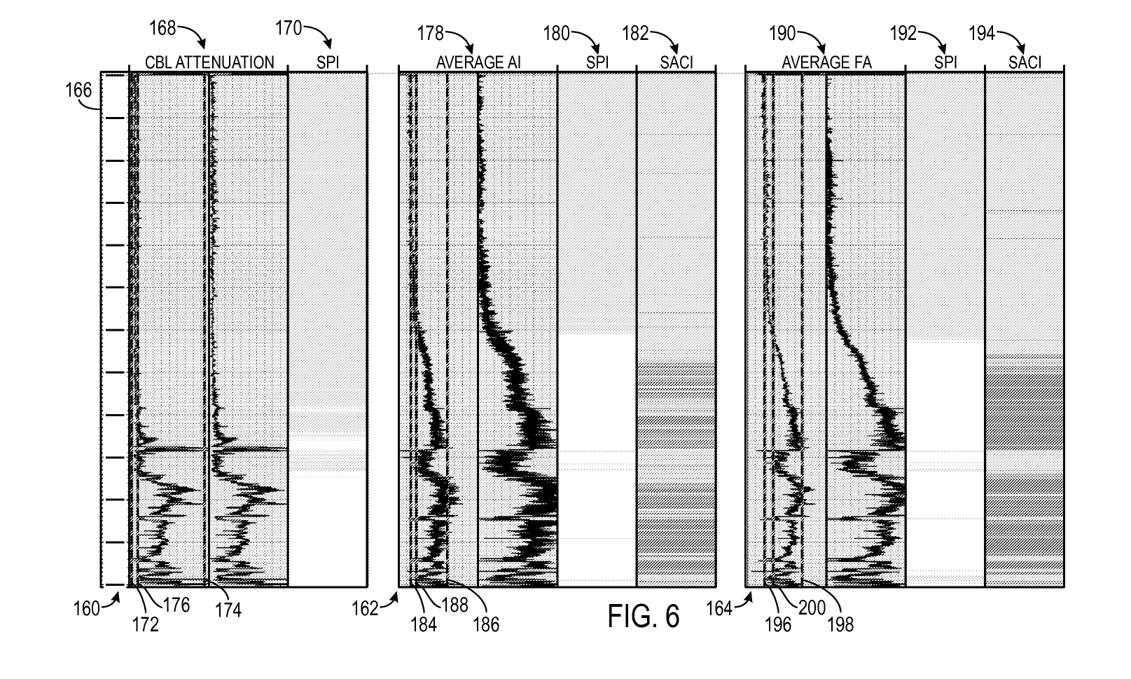

FIG. 6 provides an example of a well log that displays a Solids Presence Indicator (SPI) and/or a Solids Azimuthal Coverage Index (SACI). Specifically, FIG. 6 illustrates a Cement Bond Log (CBL) attenuation log 160, an Acoustic Impedance (AI) log 162, and a Flexural Attenuation (FA) log 164 accompanied by corresponding tracks of SPI and/or SACI. Each log 160, 162, and 164 show data obtained over a common depth interval 166.

Considering the well log 160, track 168 represents CBL attenuation and track 170 represents an associated Solids Presence Indicator (SPI). The SPI of track 170 is shown to be light when the cement 18 is indicated to be solid and dark when the cement 18 is indicated to be liquid (e.g., not present or not properly set as expected). The SPI of track 170 varies depending on the measurement shown in the track 168. Namely, a free pipe response Mfp (line 172) indicates that no cement 18 is present behind the casing 22 at that tool response, a fully cemented response Mfc (line 174) indicates that the cement 18 is fully present at that tool response, and a free pipe threshold Mfpt (line 176) indicates that the cement 18 is most likely present above that response. By moving the free pipe threshold Mfpt (line 176), the SPI may indicate more or less cement 18 coverage at various depths. As will be discussed below, however, the free pipe threshold Mfpt may be selected in an objective way with a calculable confidence.

The well logs 162 and 164 of FIG. 6 similarly indicate SPI and SACI. In these, SACI varies in darkness depending on the degree of azimuthal cement 18 coverage detected by the respective measurement.

FIG. 7 is a flowchart representing block 146 of FIG. 5. The flowchart of FIG. 7 shows that the measurement value of free pipe casing Mfp may be determined from a theoretical calculation of the measurement, an empirically collected log over a known free casing interval, or a combination of these (e.g., a weighted combination). In the example of FIG. 7, a theoretical prediction of the measurement value of the free pipe casing Mfp may be calculated (or a precalculated prediction may be retrieved from data storage) based on any suitable model of the selected measurement M that is theoretically expected in a free pipe zone (block 210). In this way, the indices and/or indicators discussed above may be determined from the measurement M without logging a known free pipe zone or without knowledge of a free pipe zone. Additionally or alternatively, an interval of a log of the measurement M for a known free pipe zone in the well may be obtained or retrieved from data storage (block 212). The measurement value of free pipe casing Mfp then may be selected as either one of these values or as some combination of these values (block 214). For example, the measurement value for free pipe casing Mfp may be selected to be a weighted average of the theoretical prediction of the measurement value M at a free pipe zone and the actual log data relating to a known free pipe zone.

FIG. 8 is a flowchart representing block 148 of FIG. 5. The flowchart of FIG. 8 shows that the measurement value of fully cemented pipe casing Mfc may be determined from a theoretical calculation of the measurement, an empirically collected log over a known fully cemented interval, or a combination of these (e.g., a weighted combination). In the example of FIG. 8, a theoretical prediction of the measurement value of the fully cemented casing Mfc may be calculated (or a precalculated prediction may be retrieved from data storage) based on any suitable model of the selected measurement M that is theoretically expected in a fully cemented zone (block 220). Using a theoretical prediction, the indices and/or indicators discussed above may be determined from the measurement M without logging a known fully cemented zone or without knowledge of a fully cemented zone. Additionally or alternatively, an interval of a log of the measurement M for a known fully cemented zone in the well may be obtained or retrieved from data storage (block 222). The measurement value of free fully cemented casing Mfc then may be selected as either one of these values or as some combination of these values (block 224). For example, the measurement value for fully cemented casing Mfc may be selected to be a weighted average of the theoretical prediction of the measurement value M at a zone of fully cemented casing and the actual log data relating to a known interval of fully cemented casing.

FIG. 9 is a flowchart representing block 150 of FIG. 5. The flowchart of FIG. 9 shows that the measurement value of the free pipe threshold Mfpt may be determined from a theoretical calculation of the measurement value, a statistical analysis of the sections of a logged interval with consistent conditions (e.g., therefore suggesting a specific fully cemented or fully free pipe condition), or a combination of these (e.g., a weighted combination). For instance, a theoretical prediction of the accuracy of the measurement value of the free pipe casing Mfp may be calculated (or a precalculated prediction may be retrieved) based on any suitable model (block 240). Additionally or alternatively, a statistical analysis may be performed regarding an accuracy of the measurement M in an interval of a log of the measurement M for a known free pipe zone in the well may be (block 242). The statistical analysis may provide a confidence value associated with the likelihood that a measurement beyond the threshold Mfpt shows a section of the casing 22 behind which the cement 18 is actually fully set. A value beyond a desired confidence may represent one possible value of the free pipe threshold Mfpt. The measurement value of free pipe threshold Mfpt then may be selected as either one of these values or as some combination of these values (block 244). For example, the measurement value for free pipe threshold Mfpt may be selected to be a weighted average of these values.

Interpretation of the M measurement may be possible when the Mfp, Mfc, and Mfpt values are clearly defined and understood. It should also be understood that the M measurement, as any physical measurement, may be subject to calibration and offset and may have certain precision, accuracy, and acquisition quality. To summarize:

Mfp—Measurement value for free pipe casing can be taken from the following sources:
theoretical estimate
log over know free casing interval
   Mfc—Measurement value for fully cemented casing can be estimated:
theoretical estimate
log over know casing interval where cement set as expected
   Mfpt—Measurement value as free pipe threshold:
theoretical accuracy of the measurement, for example Acoustic Impedance_{drilling fluid}+0.5 MRayls
Statistical assessment of the section of the logged interval with known consistent interval

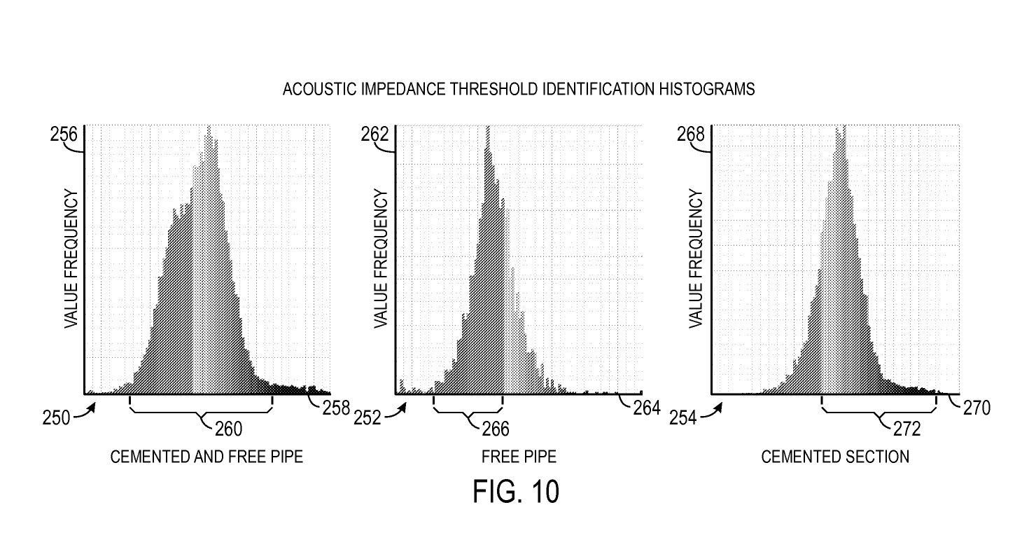

FIG. 10 shows histograms of Acoustic Impedance (AI) for which the statistical analysis may be carried out to determine Mfpt (e.g., as indicated in block 242 of FIG. 9). The distinctions between logged sections with consistent conditions may be used to ascertain a suitable Mfpt value. A histogram 250 represents values of AI for an interval of both fully cemented and free pipe, whereas a histogram 252 represents values of AI for an interval of free pipe and a histogram 254 represents values of AI for a fully cemented interval of the well.

In general, the histogram 252 is likely to represent mostly sections of free pipe and the histogram 254 is likely to represent a fully cemented section because they tend to cluster around specific values. This may be contrasted with the histogram 250, which therefore likely includes sections of both cemented and free pipe.

Looking specifically at the histogram 250, an AI value frequency (ordinate 256) is shown against the values of AI for a first interval of a well (abscissa 258). Here, the values are spread relatively widely (numeral 260) and thus, statistically, would not likely represent a specific condition of either fully cemented or free pipe, particularly as compared to the histograms 252 and 254. Indeed, by contrast, the histogram 252 shows an AI value frequency (ordinate 262) against the values of AI for a second interval of the well (abscissa 264) in which the values are clustered relatively closely together (numeral 266) around a first particular value. The histogram 254 shows an AI value frequency (ordinate 268) against the values of AI for a third interval of the well (abscissa 270) in which the values are clustered relatively closely together (numeral 272) around a second particular value. Because the second particular value of the histogram 254 and the first particular value of the histogram 252 are apart from one another, it logically follows that these values may indicate that the respective logging intervals associated with the histograms 252 and 254 represent intervals of different cement conditions (i.e., that one is more likely free pipe and one more likely fully cemented).

Considering the information represented by histograms such as 250, 252, and 254, the Mfpt value may be determined by selecting, for example, a value some statistical amount higher than the likely free pipe value. For instance, the Mfpt value may be selected to be one standard deviation, two standard deviations, three standard deviations, or more, as suitable, above the likely free pipe value. Depending on the statistical value of the Mfpt that is selected, a particular statistical confidence may be accordingly attributed. This allows for an object measure of confidence to support interpretations of the data 36 from the acoustic logging tool 26.

In some examples, certainty can be assigned to the interpretation using a threshold Mfpt that was picked based on statistical evaluation of the measurement of the known interval in the well. As can be seen in FIG. 10, the free casing interval data variance may resemble normal distribution. Applying a statistical analysis on the free casing interval allows calculate median, average and standard deviation of the measurement. In some embodiments, the threshold Mfpt can be picked as a midpoint between average measurement in free pipe and cemented section. In this case, there is more than 50% probability that data past threshold represent cement. Probability goes higher when measured values are getting past midpoint, closer to the cement values. Threshold can also be determined by using standard deviation of the measured values.

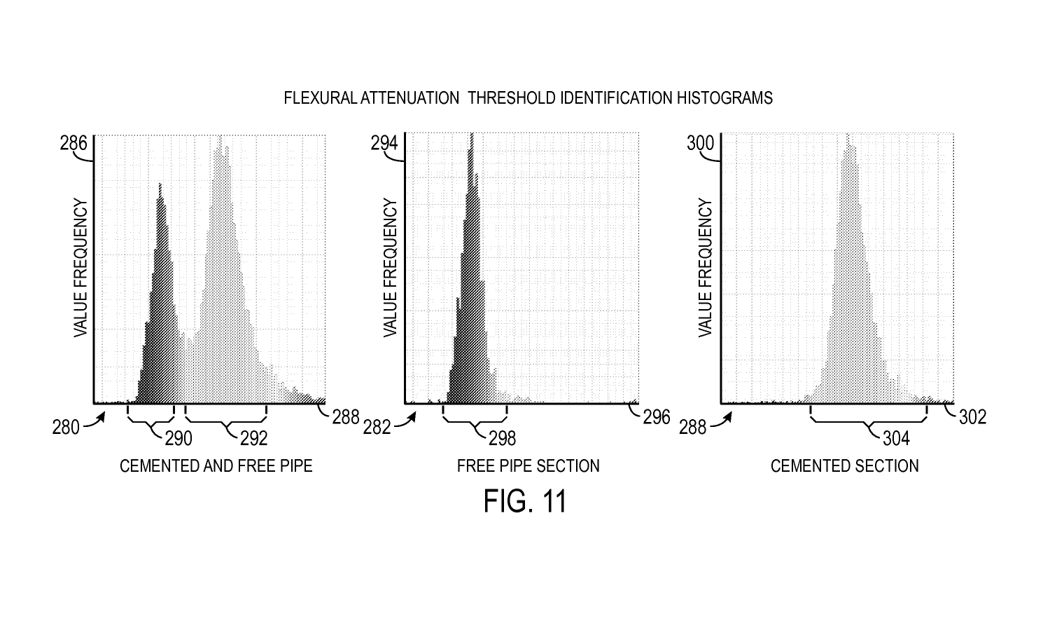

Similar histograms of Flexural Attenuation (FA) measurements appear in FIG. 11. These also may be used to determine Mfpt. Indeed, a histogram 280 represents measurements from both cemented and free pipe sections, while a histogram 282 represents FA measurements from a free pipe section and a histogram 284 represents FA measurements from a cemented section.

Looking specifically at the histogram 280, an FA value frequency (ordinate 286) is shown against the values of FA for a first interval of a well (abscissa 288). Here, the values form two distinct modal peaks (numerals 290 and 292) and thus, statistically, appear to relate to two distinct well conditions. That is, looking at the histogram 280, the range of values indicated by numeral 290 appear at first glance to relate to a free pipe zone, while the range of values indicated by numeral 292 appear to relate to a fully cemented zone. Indeed, the histogram 282 shows an FA value frequency (ordinate 294) against the values of FA for a second interval of the well (abscissa 296) in which the values are clustered relatively closely together (numeral 266) around the same value as the range indicated by numeral 290 of the histogram 280. This further strengthens the confidence that the range indicated by numeral 290 of the histogram 280 and the range indicated by the numeral 298 of the histogram 282 both relate to a common well condition. Here, that common well condition may be understood to be a free pipe zone because it is lower than the range of FA values indicated by numeral 292. This is further supported by the histogram 284, shows an AI value frequency (ordinate 300) against the values of FA for a third interval of the well (abscissa 302) in which the values are clustered relatively closely together (numeral 304) around the same value as the range of FA values indicated by numeral 292.

Because the FA values are so distinct and accurate in this example, a statistically selected value of Mfpt may have a greater confidence value for a given range of values on the basis of such values. This may also be used to indicate that certain measurements may be more appropriate for certain situations. For example, in the example of FIGS. 10 and 11, FA measurement may provide a more likely accurate interpretation of whether the cement 18 has been properly installed and set and/or where the top of the cement is in the well. Moreover, in some examples, an interval of FA measurements that is statistically more likely to be free pipe may be used to identify values of other measurements (e.g., AI measurements) in that interval as likely pertaining to a free pipe zone. Similarly, an interval of FA measurements that is statistically more likely to be fully cemented may be used to identify values of other measurements (e.g., AI measurements) in that interval as likely pertaining to a fully cemented zone.

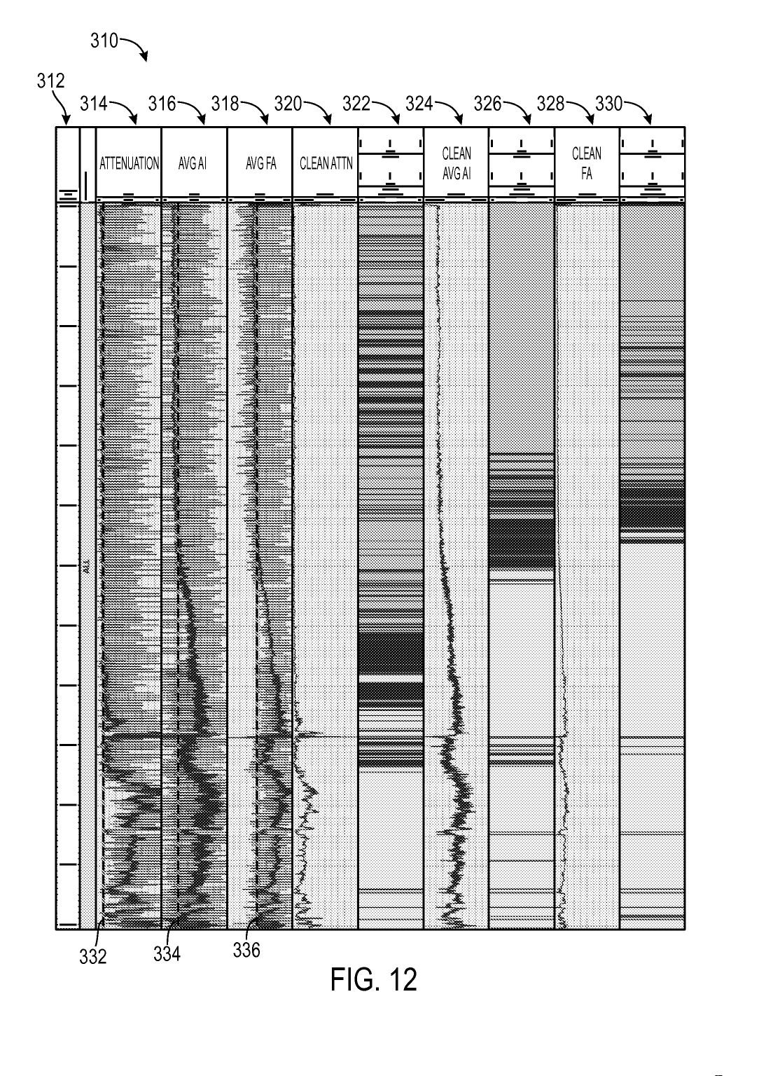

FIG. 12 provides an example of a log 310 that includes an SPI with varying degrees of confidence as obtained with various measurements. Here, the Mfpt value has been selected statistically to provide a relatively high degree of confidence (e.g., 95% from selecting Mfpt as two standard deviations above the Mfp value). The log 310 includes a depth track 312 that shows the depths of the interval of the well presented in the log 310. Tracks 314, 316, and 318 show raw measurements M of attenuation (CBL), average AI, and average FA, respectively. Track 320 shows a filtered (“clean”) measurement of attenuation. Track 322 shows SPI calculated based on the clean CBL Attenuation measurement of track 320. Track 324 shows a filtered (“clean”) measurement of average AI. Track 326 shows SPI calculated based on the clean measurement of AI of track 324. Track 328 shows a filtered (“clean”) measurement of average FA. Track 330 shows SPI calculated based on the clean measurement of FA of track 328.

In one interpretation of the log 310, black areas of the SPI tracks 322, 326, and 328 indicate data outside the range of confidence for likely fully cemented or free pipe; gray areas indicate data within the range of confidence for likely free pipe; and white areas indicate data within the range of confidence for likely fully cemented pipe. These may be easily compared by a field engineer to the values of the measurements M on which the SPI tracks are based, as well as to one another.

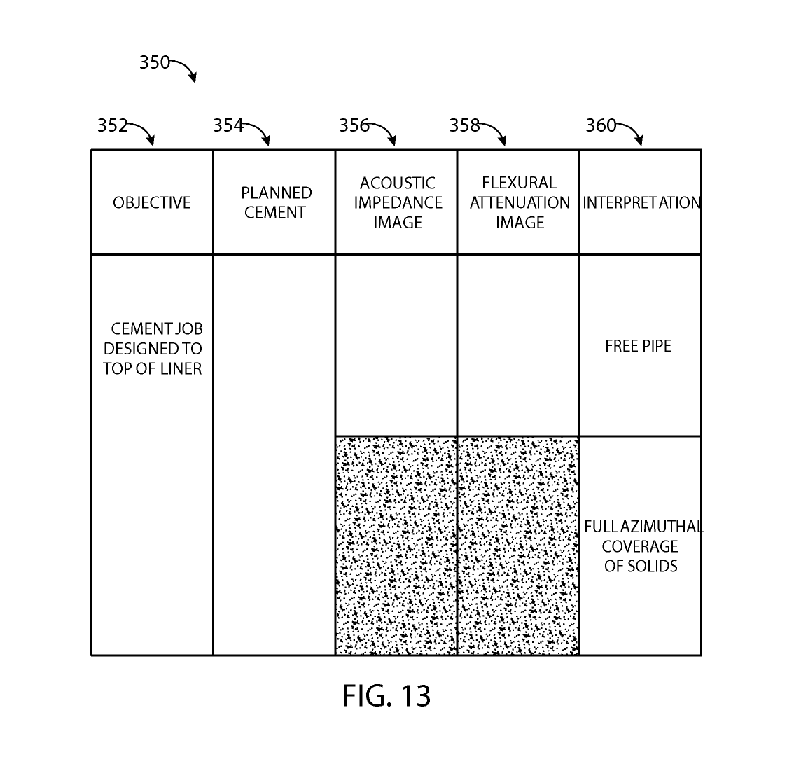

FIGS. 13-17 illustrate schematic drawings of well logs that relate to two real-world examples in which more objective measurements such as Solids Presence Indicator (SPI), Solids Index (SI), Solids Azimuthal Coverage Index (SACI), and/or Azimuthal Coverage Indicator (ACI) may be used to improve cement evaluation. Moreover, rather than relying just on cement evaluation measurements to identify potential cement installation challenges, additional information relating to the well may be included in a cement evaluation well log to more comprehensively explain the well.

### First Example

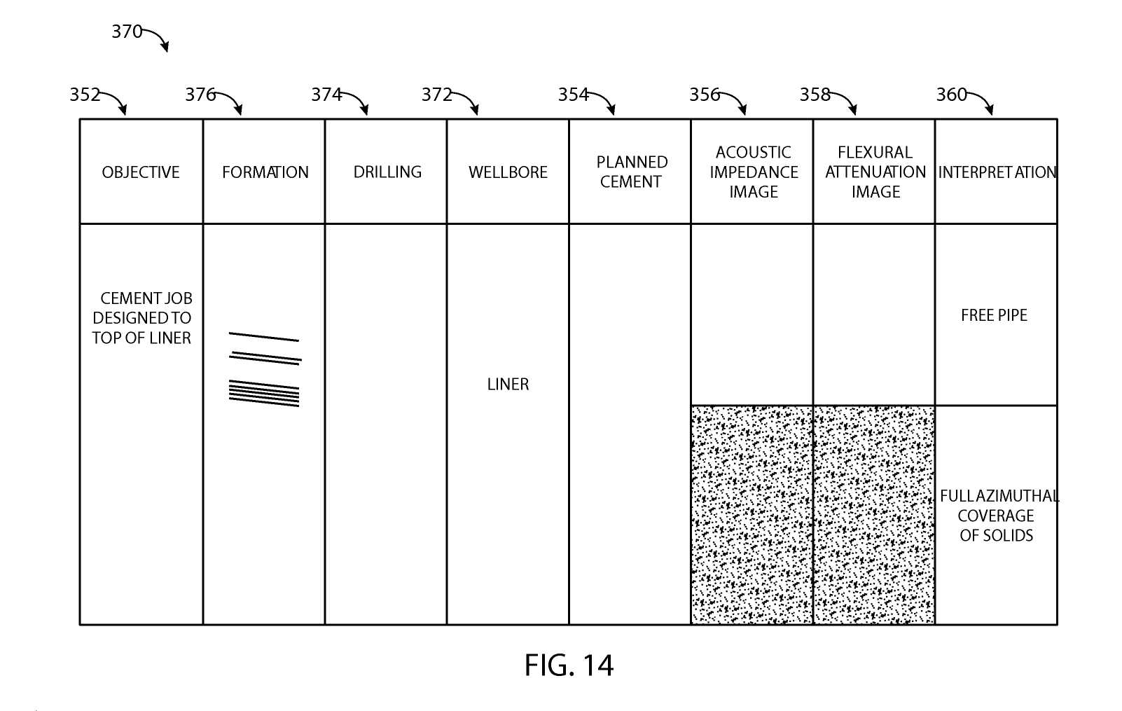

FIGS. 13 and 14 are well logs that relate to a first of the two examples. In the first example, a top down liner squeeze was performed with the objective of cementing to the top of the liner. Successful cement placement was expected based on surface indicators. However, the cement evaluation log indicated the top of solids to be 600 feet deeper than expected, as can be seen in FIG. 13, which shows a log 350 of a well interval. Track 352 provides an objective of the job, track 354 shows planned cement location, track 356 shows an acoustic impedance (AI) measurement, track 358 shows a flexural attenuation (FA) measurement, and track 360 shows an interpretation of the data.

FIG. 14 shows a log 370 having additional information that may be used to provide insight into challenges that may arise in evaluating cement beyond what may be initially ascertainable solely using post-hoc cement evaluation measurements. In addition to the tracks 352, 354, 356, 358, and 360, the log 370 also includes a track 372 showing wellbore-related information, a track 374 showing drilling notes, and a track 376 showing formation characteristics (e.g., a Geological Image log). After reviewing the available well data in the log 370 of FIG. 14, which includes the Geological Image log, natural fractures were identified directly above the interpreted top of solids, as can be seen in FIG. 14.

### Second Example

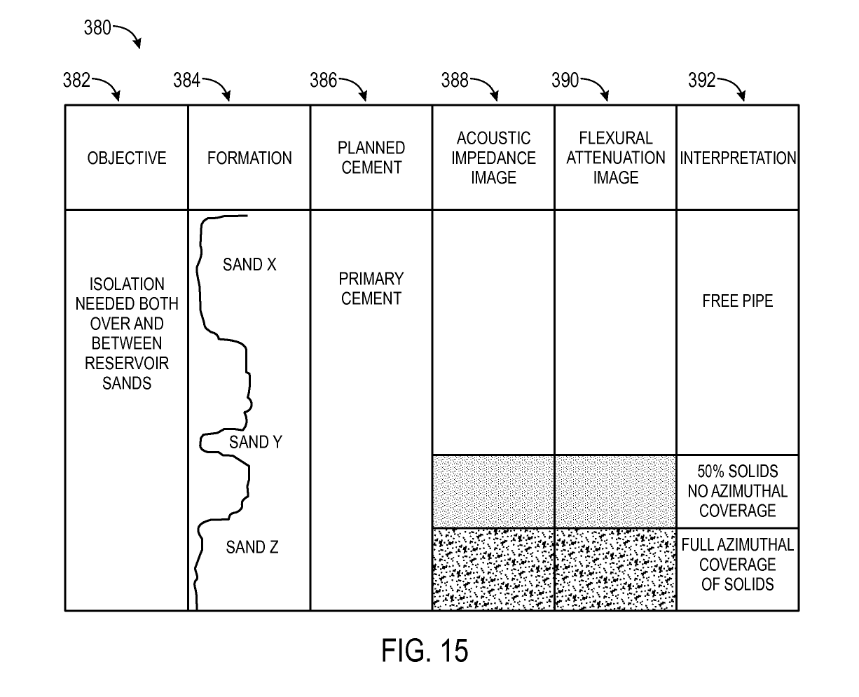

FIGS. 15-17 are well logs that relate to a second of the two examples. In the second example, an injector well was cemented with the objective of achieving isolation both over and between sands X, Y and Z. FIG. 15 represents an initial log 380 of this example that includes a track 382, listing the objectives of the job, a track 384 representing formation characteristics, a track 386 illustrating planned cement, a track 388 showing an acoustic impedance (AI) image, a track 390 showing a flexural attenuation (FA) image, and a track 392 showing an interpretation of the information presented in the other tracks. From the initial log 380 of FIG. 15, it may be seen that the cement evaluation log indicated the top of solids to be much deeper than expected, and the primary cementing objective was not achieved.

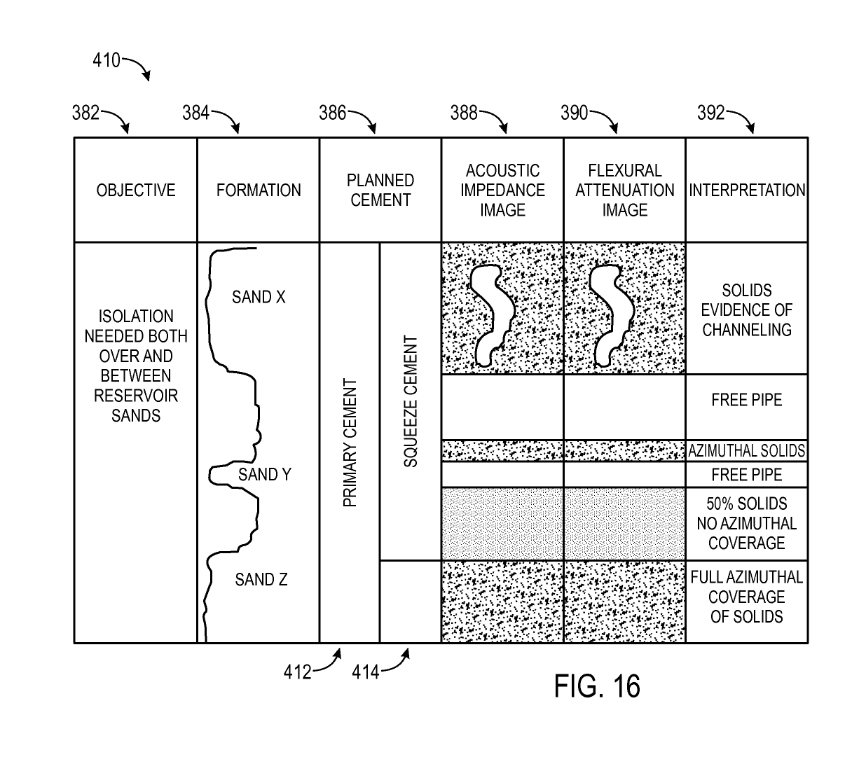

The effectiveness of immediate and future injectivity profile resulted in remedial action prior to well completion. The production casing was perforated to enable a remedial squeeze, after which the cement evaluation logs were run again. Additional solids were noted after the squeeze, over Sand X and a short interval between sands X and Y, as shown by a second log 410 of FIG. 16. As shown in the log 410, solids were not seen over Sand Y.

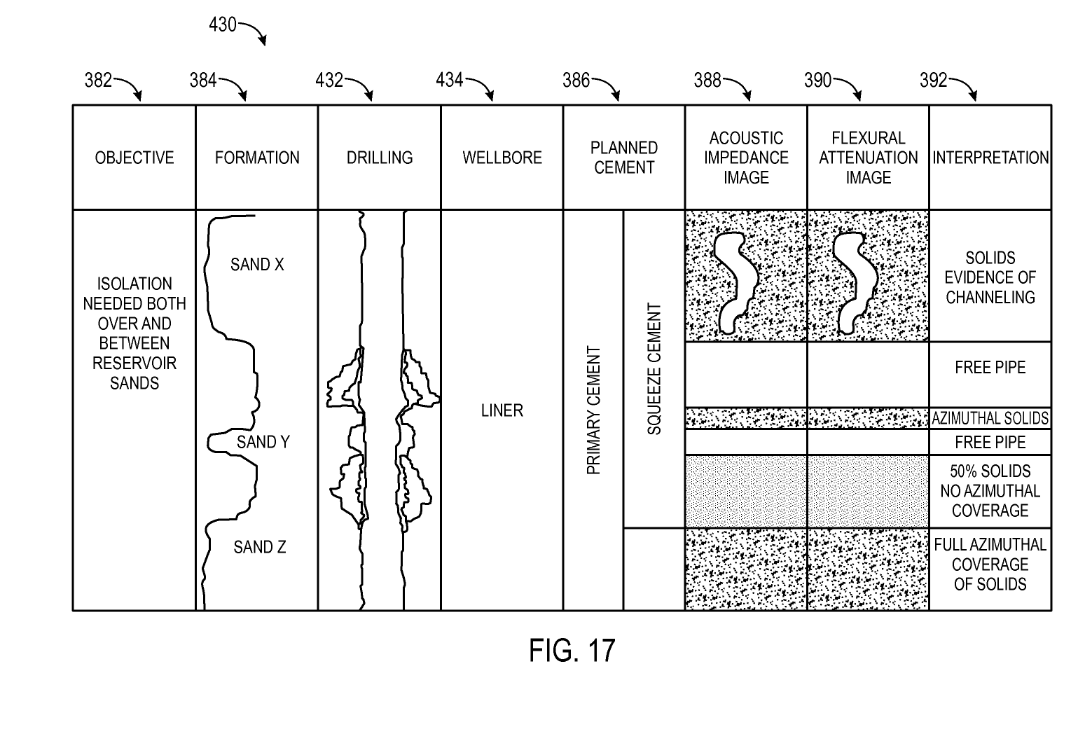

A log 430 of FIG. 17 includes additional information that may be used to provide insight into challenges that may arise in evaluating cement beyond what may be initially ascertainable solely using post-hoc cement evaluation measurements. Namely, the log 430 of FIG. 17 also includes a track 432 with additional drilling data and a track 434 indicating wellbore conditions. Since condition of the wellbore and pipe centralization is related to successful cement placement, reviewing the log 430 provided available well data. An LWD image log indicated Sand Y was situated between two ovalized shales where mud losses were evident, as seen in FIG. 17. This enabled a better completion of the cement job.

These two cases are also a demonstration of the value of data integration when evaluating cement placement. When completing an evaluation, it may be useful to compare job results versus job objectives and expectations. When the interpreted top of cement is not at the designed depth, and the question is asked, “where did the cement go?” it is difficult to explain what went wrong with limited data. What may be done is to review the cementing logs and the actual cementing job itself. However, integrating available petrophysical data, geological data, cementing information and cement evaluation logs can offer additional explanations to such questions.

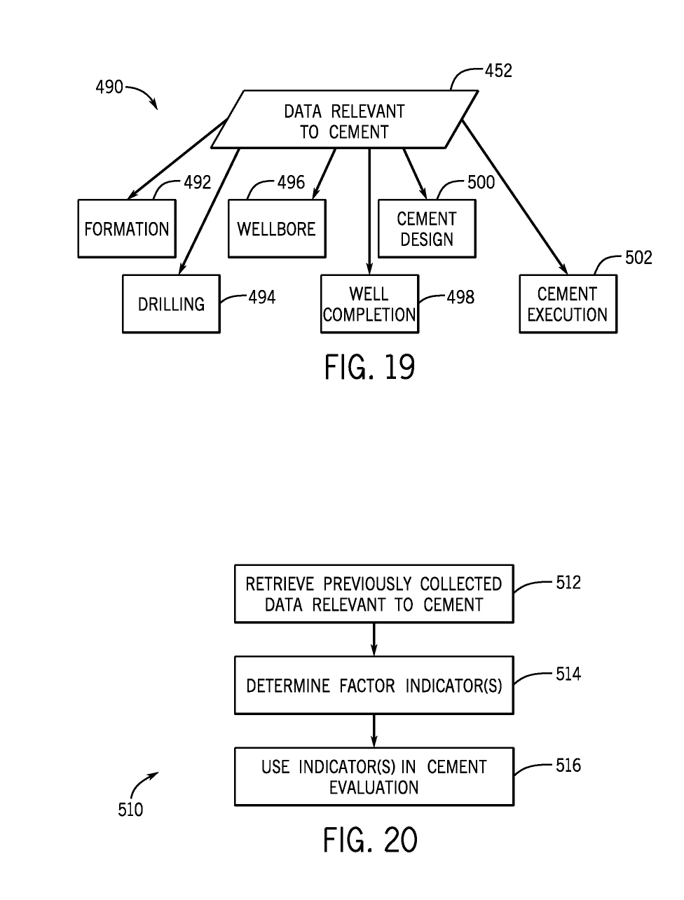

FIG. 18 is a flowchart 450 of such an integrated cement evaluation method. While a well is being drilled and completed, certain data 452 relevant to the future cement evaluation are stored (block 454) in a storage device (e.g., the storage 44 or a remote storage facility). In some embodiments, data 452 may be saved (block 454). In some embodiments, just data 452 from certain stages of the drilling and completion of the well may be saved and stored (block 454). The flowchart of FIG. 18 is intended to be an example, and certain blocks shown in FIG. 18 may be performed in an alternative order as may be suitable. The type of data 452 that may be relevant to cement installation is discussed in greater detail below with reference to FIG. 19.

In the flowchart of FIG. 18, as a well is designed (block 456), at least some data 452 relevant to the cement may be ascertained and stored (block 454). As the well is drilled (block 458), which may involve logging-while-drilling (LWD) (block 460) and/or measurement-while-drilling (MWD) (block 462), at least some data 452 relevant to the cement may be ascertained and stored (block 454). Formation properties may be obtained (block 464) (e.g., via wireline or logging while drilling), and at least some data 452 relevant to the cement may be ascertained and stored (block 454). Well completions (block 466) may be conducted, which may include installing the casing 22 (block 468), designing the cement installation (block 470), executing the cement installation (block 472), and at least some data 452 relevant to the cement may be ascertained and stored (block 454).

The data 452 relevant to the cement that has been stored (block 454) may be used in an integrated cement evaluation (block 476). The integrated cement evaluation may involve obtaining the acoustic logs discussed above (block 478) and evaluating the other data relevant to the cement that was stored in the cement evaluation storage (block 480). The collection of this data may be presented in an integrated log (block 482), such as the integrated logs discussed above and below.

FIG. 19 is a schematic representation of various factors that may be established from the data 452 relevant to the cement. These may be as follows:

Formation information (block 492):
a. Permeable/not permeable—Lithology—(e.g., gamma-ray logging)
b. Permeable—water, oil, gas—Resistivity, Fluid samples
c. Salt—(e.g., as determined by gamma-ray logging and/or elemental capture spectroscopy logging)
d. Unstable formation—caliper—washouts
e. Natural fractures
f. Pore pressure (e.g., predicted pore pressure)
g. Fracture pressure (e.g., predicted and/or interpreted)

Drilling information (block 494):
a. Weight on bit (WOB), rate of penetration (ROP), rotations per minute (RPM) of the drill at various depths.
b. Mechanical practices—back reaming/circulating bottom up (BU)
c. Issues—Fluid losses
d. Mud rheology, compressibility, compatibility, additives
e. Induced fractures
f. Pore pressure

Wellbore information (block 496):
a. Caliper—caliper
b. Oval borehole—azimuthal caliper—2,4,6 arms, LWD ultrasonic
c. Deviation—curve, flagged
d. WellBore geometry—tortuosity of the wellbore
e. Over/under gauge hole
f. Horizontal well—deviation flag

Well Completion information (block 498):
a. Casing completion—well sketch
b. Casing centralization—followed centralization design
c. Whether the well has been Fractured

Cement Design information (block 500):
a. Centralizer program available/used in cement design
b. Caliper log available/used in cement design to estimate excess of the hole
c. Volumetric expected cement slurry placement
d. Modeled mud removal map
e. Modeled fluid placement map
f. Expected Acoustic Impedance of the cement from UCA

Cement Execution information (block 502):
a. Any deviation from the cement design
b. Analysis of the cementing execution data (e.g., QC plugs did not bump, float valve did not hold, over displacement, density control, losses)
c. Playback of the cementing execution data
d. Events after cementing job—before cement evaluation—changing borehole fluid, wellbore pressure, temperature, hydraulic fracturing, drilling (e.g., damaging cement).

This may result as a very large volume of data. However, the information may be useful for truly comprehensive cement evaluation and thus may be assessed before/during interpretation of the cement placement. It should be appreciated that the specific usefulness of each point of data 452 as listed above may vary depending on other related points of data 452. The relationship of each of these points of data 452 to the evaluation of cement installation may be better understood through experimentation and experience, but may provide a substantial insight over purely post-hoc cement evaluation logs.

To manage and utilize this data 452, indicators for each major factor 492, 494, 496, 498, 500, and/or 502 may be established. As shown in a flowchart 510 of FIG. 20, the factors 492, 494, 496, 498, 500, and/or 502 listed above, in some embodiments, may be used to create indicators that may flag particularly likely causes of cement failure or challenges. The flowchart 510 may begin when the relevant data 452 is collected (block 512). Thereafter, various indicators may be determined based on the factors 492, 494, 496, 498, 500, and/or 502 (block 514). For example, a formation factor 492 indicator may be determined based on one or more of the formation factors 492 indicated above; a drilling factor 494 indicator may be determined based on one or more of the drilling factors 494 indicated above; a wellbore factor 496 indicator may be determined based on one or more of the wellbore factors 496 indicated above; a well completion factor 498 indicator may be determined based on one or more of the well completion factors 498 indicated above; a cement design factor 500 indicator may be determined based on one or more of the cement design factors 500 indicated above; and/or a cement execution factor 502 indicator may be determined based on one or more of the cement execution factors 502 indicated above. The indicators may be determined using any of the data 452 relevant to the cement that provides a suggestion that the cement may be more likely than otherwise to fail given that data. For example, a threshold may be determined based on various values relating to the

These indicators and/or the original data 452 relevant to cement that has been stored (block 454) may enable the ability to perform in-house analysis and interpretation by a subject matter expert and then present “raw” data with supported interpretation summary indicators, while also allowing simplified and quick assessment of the well integrity (WI) of the wellbore 16. The indicators may speed up the overall interpretation process and may bring numerical value to the quality of the each factor for well integrity. In addition, the indicators may assist interpretation for less experienced personnel.

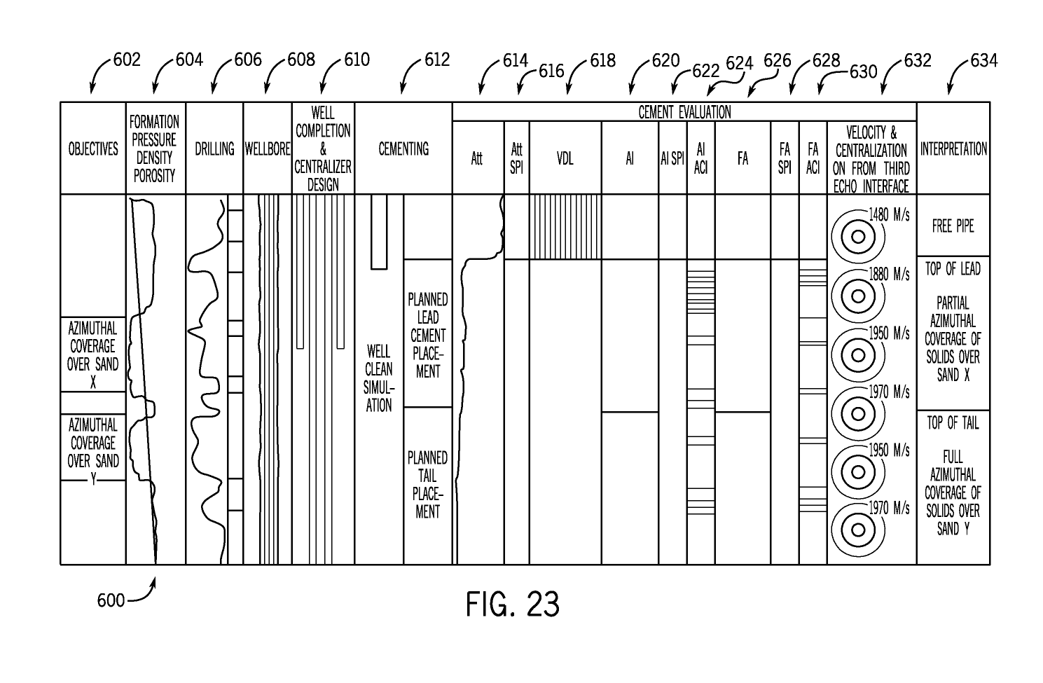

FIG. 23 is a flowchart 520 providing one example of integrated cement evaluation. Specifically, the flowchart 520 may begin when a project is created (block 522) to collect and process the data 452 relevant to cement evaluation. When logging while drilling (LWD) data is available (decision block 524), the LWD channels may be collected (block 526) or, alternatively, open hole (OH) channels may be collected (block 530). A well integrity engineer or a process running on the data processing system 38 may review the interpretation of the well using these channels (block 530), which generally relate to the petrophysics of the well. For instance, the actions of block 530 may involve determining and/or reviewing indicators such as those discussed above.

At block 532, measurement-while-drilling (MWD) channels may be collected and added to the LWD and/or OH channels. An MWD engineer or a process running on the data processing system 38 may review the interpretation of the well using these channels (block 534), which generally relate to the characteristics of the well as drilled. For instance, the actions of block 534 may involve determining and/or reviewing indicators such as those discussed above. Among other things, the MWD data may indicate well deviation and/or characteristics of the well as drilled that may affect the integrity of cement that will be placed.

Having collected the LWD and/or OH channels and the MWD channels, at block 536, surface data (e.g., well drilling fluid properties, etc.) may be added and evaluated. An engineer or a process running on the data processing system 38 may review the interpretation of the well using this data (block 538). After evaluating the known information from drilling the well and certain surface data relating to the well, cement job data may also be added (block 540) and interpreted by an engineer or a process running on the data processing system 38 (block 542). In some embodiments, the cement job data 540 may itself have been developed at least partly based on the interpretation of block 538. When acoustic logs data is added (block 544), an integrated interpretation may take place using the data by an engineer or a process running on the data processing system 38 (block 546). From the interpretation of block 546, a top of the cement and azimuthal coverage determination may be defined (block 548) and indicated on the integrated layout presented to the client (block 550). The integrated layout may also be archived (block 552).

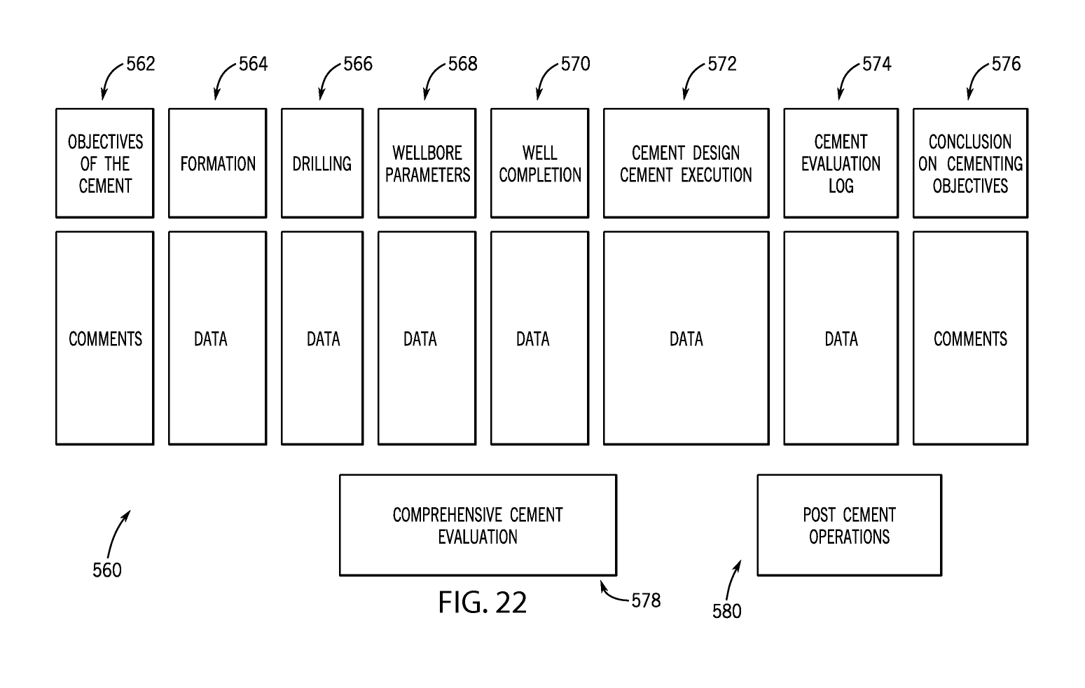

FIG. 22 illustrates a block diagram that includes log data that may be combined into an integrated cement evaluation log 560. Here, a track 562 includes objectives of the cement job, a track 564 includes formation-related data, a track 566 includes drilling-related data, a track 568 provides wellbore parameters, a track 570 provides well completion data, a track 572 provides cement design and execution data, a track 574 provides cement evaluation log data, and a track 576 provides comments on the cementing objectives in light of the data provided by the other tracks. Some of the tracks (e.g., tracks 562, 564, 566, 568, 570, and 572) may represent comprehensive cement evaluation 578 tracks. Some of the tracks (e.g., track 574) may represent post cement operations 580 tracks.

As it was mentioned earlier, the factors stated above may be useful for evaluation of the barrier. It may be a difficult task to combine this information together in a meaningful form. Indeed, the data relevant to the cement may be obtained in advance, rather than merely attempting to comb through or collect the data at the time of the cement evaluation. Having an integrated layout for the data relevant to the cement along with the acoustic logging data may allow in-time/pre-job preparation/planning, which may allow a substantially real-time decision process. Moreover, this data integration can be used for production planning, perforating interval decision, and future improvements. The data integration shown in FIG. 22 may also improve efficiency of communication between departments and common depth references may decrease confusion and mistakes that might otherwise occur. Moreover, the information may not need to be presented in an ordinary way. Instead, it may reflect relevance to zonal isolation and quality of the cement as generally represented in FIG. 22. The indicators and flags discussed above further may enable a quick assessment of the integrated cement evaluation interpretation.

FIG. 23 is an example integrated well log 600 generated for integrated cement evaluation. The example well log of FIG. 23 generally comports with the block diagram of FIG. 22. Here, a track 602 includes objectives of the cement job, a track 604 includes formation-related data, a track 606 includes drilling-related data, a track 608 provides wellbore parameters, a track 610 provides well completion data, a track 612 provides cement design and execution data. Tracks 614, 616, 618, 620, 622, 624, 626, 628, 630, and 632 provide cement evaluation log data. In the example of FIG. 23, track 614 represents attenuation (CBL), track 616 represents SPI based on attenuation, track 618 represents variable density log, track 620 represents acoustic impedance (AI), track 622 represents SPI based on AI, track 624 represents ACI based on AI, track 626 represent flexural attenuation (FA), track 628 represents SPI based on FA, and track 630 represents ACI based on FA. A track 634 provides comments on the cementing objectives in light of the data provided by the other tracks.

To summarize, it may be appreciated that specific data flows and data integration in one place may benefit from clear workflows. By using developed workflows to collect and integrate in one place the data used for interpretation (e.g., as shown in FIG. 18), this disparate and otherwise uncoordinated data may be combined in the integrated cement evaluation. The integrated cement evaluation discussed in this disclosure may allow the practice of more robust or trustworthy interpretation. Indeed, it may not just allow the identification of cement barrier problems, but also may help highlight the possible cause and explanation of such problems. Finally, as data is accumulated over various well cycles, the assessment of the potential integrity of the each well can be done even during beginning of the well cycle. Certainty may further continue to improve as additional integrated well logging takes place.

Indeed, to provide another concrete example, the cement evaluation process may even be made more efficient. Given the high cost of delay (e.g., in terms of rig rental costs and lost production), obtaining a determination that the cement has been properly installed as early as possible may save substantial time, energy, and cost. To provide one example, by following the process of FIG. 21—considering the integrated data 452 relevant to cement as it is collected—may allow a determination that the acoustic logs may be run earlier than a most conservative estimate. For instance, when the formation-related data, drilling-related data, and wellbore parameters indicate that cement is likely to set properly (e.g., there are no apparent channels for the cement to exit through), the acoustic logs may be run earlier because the cement is likely to set more quickly. This may confirm that the cement has been properly installed sooner, rather than later, to enable the well to be completed and ready for production sooner. In some cases, this may speed the development of the well by 42-72 hours or more.

The specific embodiments described above have been shown by way of example, and it should be understood that these embodiments may be susceptible to various modifications and alternative forms. It should be further understood that the claims are not intended to be limited to the particular forms disclosed, but rather to cover modifications, equivalents, and alternatives falling within the spirit and scope of this disclosure.

1. A method comprising:
obtaining at least one acoustic tool response over a depth interval in a cased and cemented well;
determining a value of a measurement at a depth based at least in part on the at least one acoustic tool response;
determining a measurement value associated with a free pipe casing;
determining a measurement value associated with a fully cemented casing;
determining a measurement value associated with a free pipe threshold; and
calculating an indicator or an index relating the measurement at the depth to a presence or absence of cement at the depth based at least in part on the value of the measurement, the measurement value associated with a free pipe casing, the measurement value associated with a fully cemented casing, and the measurement value associated with a free pipe threshold;
wherein the measurement value associated with the free pipe threshold is determined according to an objective determination.

2. The method of claim 1, wherein the measurement value associated with the free pipe casing is determined based at least in part on a theoretical prediction of an expected value of the measurement from the at least one acoustic tool response over a free pipe interval.

3. The method of claim 1, wherein the measurement value associated with the free pipe casing is determined based at least in part on an empirically obtained measurement from the at least one acoustic tool response over a known free pipe interval.

4. The method of claim 1, wherein the measurement value associated with the free pipe casing is determined as a weighted average of an empirically obtained measurement from the at least one acoustic tool response over a known free pipe interval and a theoretical prediction of an expected value of the measurement over a free pipe interval from the at least one acoustic tool response.

5. The method of claim 1, wherein the measurement value associated with the fully cemented casing is determined based at least in part on a theoretical prediction of an expected value of the measurement from the at least one acoustic tool response over a fully cased interval.

6. The method of claim 1, wherein the measurement value associated with the fully cemented casing is determined based at least in part on an empirically obtained measurement from the at least one acoustic tool response over a known interval of fully cemented casing.

7. The method of claim 1, wherein the measurement value associated with the fully cemented casing is determined as a weighted average of an empirically obtained measurement from the at least one acoustic tool response over a known interval of fully cemented casing and a theoretical prediction of an expected value of the measurement over a fully cased interval from the at least one acoustic tool response.

8. The method of claim 1, wherein the measurement value associated with the free pipe threshold is determined based at least in part on a statistical analysis of the at least one acoustic tool response over the depth interval.

9. The method of claim 1, wherein the measurement value associated with the free pipe threshold is determined based at least in part on a theoretical prediction of an expected accuracy of the measurement value of the free pipe threshold or the expected accuracy of the measurement value of the fully cemented casing, or both.

10. The method of claim 1, wherein the measurement value associated with the free pipe threshold is determined as a weighted average of a first value determined based at least in part on a statistical analysis of the at least one acoustic tool response over the depth interval and a second value determined based at least in part on a theoretical prediction of an expected accuracy of the measurement value of the free pipe threshold or the expected accuracy of the measurement value of the fully cemented casing, or both.

11. A tangible, non-transitory, machine-readable medium comprising processor-executable instructions to:
receive acoustic log measurement values over a depth interval of a well that has been at least attempted to be cased and cemented;
determine a measurement value associated with a free pipe casing;
determine a measurement value associated with a fully cemented casing;
determine an objective measurement value associated with a free pipe threshold; and
calculate an indicator or an index relating the measurement at the depth to a presence or absence of cement over the depth interval based at least in part on the value of the measurement, the measurement value associated with a free pipe casing, the measurement value associated with a fully cemented casing, and the measurement value associated with a free pipe threshold.

12. The tangible, machine-readable media of claim 11, wherein the instructions to calculate the indicator or the index comprise instructions to calculate a solids presence indicator that flags when the measurement values exceed the measurement value associated with a free pipe threshold as being fully cemented.

13. The tangible, machine-readable media of claim 11, wherein the instructions to calculate the indicator or the index comprise instructions to calculate a solids presence indicator (SPI) according to the following relationship:
$$SPI = \{ \begin{matrix}0 , M \leq {M}_{fpt} \\ 1 , M > {M}_{fpt}\end{matrix}$$
where M represents measurement values and M_{fpt} represents the measurement value associated with a free pipe threshold.

14. The tangible, machine-readable media of claim 11, wherein the instructions to calculate the indicator or the index comprise instructions to calculate a solids index that indicates a linear percentage of measurement values between the measurement value associated with a free pipe casing and the measurement value associated with a fully cemented casing.

15. The tangible, machine-readable media of claim 11, wherein the instructions to calculate the indicator or the index comprise instructions to calculate a solids index (SI) according to the following relationship:
$$SI = \frac{( M - {M}_{fp} )}{( {M}_{fc} - {M}_{fp} )}$$
where M=Mₐᵥ for azimuthal measurement, where Mₐᵥ represents an average of azimuthal measurements for each particular depth, M_{fp} represents the measurement value associated with a free pipe casing, and M_{fc} represents the measurement value associated with a fully cemented casing.

16. The tangible, machine-readable media of claim 11, wherein the instructions to calculate the indicator or the index comprise instructions to calculate a solid azimuthal coverage index that indicates a linear percentage of azimuthal measurement values at a given depth that are above the measurement value associated with a free pipe threshold.

17. The tangible, machine-readable media of claim 11, wherein the instructions to calculate the indicator or the index comprise instructions to calculate a solids azimuthal coverage index (SACI) according to the following relationship:
$$SACI = \frac{1}{N} \times {\sum }_{i = 1}^{N} \{ \begin{matrix}0 , {M}_{i} \leq {M}_{fpt} \\ 1 , {M}_{i} > {M}_{fpt}\end{matrix}$$
where N represents the number of azimuthal measurements for each particular depth, Mᵢ represents a particular azimuthal measurement at a particular depth, and M_{fpt} represents the measurement value associated with a free pipe casing threshold.

18. The tangible, machine-readable media of claim 17, wherein the instructions to calculate the indicator or the index comprise instructions to calculate an azimuthal coverage indicator (ACI) according to the following relationship:
$$ACI = \{ \begin{matrix}0 , SACI < CP \\ 1 , SACI \geq CP\end{matrix}$$
where CP represents a threshold percentage of coverage beyond which the casing at the particular depth is deemed to be fully cemented.

19. The tangible, machine-readable media of claim 11, wherein the instructions to calculate the indicator or the index comprise instructions to calculate an azimuthal coverage indicator (ACI) that flags when a coverage percentage threshold of azimuthal measurement values of the acoustic log measurement values for a given depth exceeds the measurement value associated with a free pipe casing threshold.

20. An integrated cement evaluation well log comprising:
a track comprising data obtained by an acoustic cement evaluation logging tool; and
one or more tracks comprising:
logging-while-drilling or open hole logging information;
drilling information;
wellbore information;
well completion information;
cement design information; or
cement execution information; or
any combination thereof.

21-22. (canceled)
